(19) United States
(12) Patent Application Publication
(10) Pub. No.: US 2026/0284736 A1
(43) Pub. Date: Sep. 24, 2026

(54) SAND CORE, SAND MOLD AND METHOD FOR MANUFACTURING A SAND CORE

(71) Applicant: ATLAS COPCO AIRPOWER, NAAMLOZE VENNOOTSCHAP, Wilrijk (BE)

(72) Inventors: Karolien KEMPEN, Wilrijk (BE); Rob HOOGMARTENS, Wilrijk (BE); Victor ADRIAENS, Wilrijk (BE)

(73) Assignee: ATLAS COPCO AIRPOWER, NAAMLOZE VENNOOTSCHAP, Wilrijk (BE)

(21) Appl. No.: 19/472,828

(22) PCT Filed: Apr. 11, 2024
(86) PCT No.: PCT/IB2024/053539

§ 371 Date: Oct. 6, 2025

Related U.S. Application Data
(60) Provisional application No. 63/459,305, filed on Apr. 14, 2023.

(30) Foreign Application Priority Data
Nov. 9, 2023 (BE) 2023/5920

(51) Int. Cl. B22C 9/10; B22C 9/02; B22D 19/00; B33Y 80/00

(52) U.S. Cl. CPC B22C 9/10; B22C 9/02; B22D 19/00; B33Y 80/00

(57) ABSTRACT

A sand core for casting a housing of an element for compressing or expanding a gas, wherein the sand core (11, 21) includes a partial core (12, 22) having a profile for fully or largely forming an inner surface or interior space of the housing, wherein the partial core (12, 22) includes one integral monoblock structure (13, 23).

### CROSS-REFERENCE TO RELATED APPLICATIONS

This is a National Stage of International Application No. PCT/IB2024/053539 filed Apr. 11, 2024, claiming priority based on U.S. Provisional Application No. 63/459,305 filed Apr. 14, 2023 and Belgian Patent Application No. 2023/5920 filed Nov. 9, 2023.

### BACKGROUND OF THE INVENTION

### Field of the Invention

The present invention relates to a sand core, to a sand mold, to a method for manufacturing a sand core, and to a method for casting a housing of an element for compressing or expanding a gas.

An “element for compressing or expanding a gas” can mean, for example, a compressor element, a blower element, a vacuum pump element or an expander element.

More specifically, the invention relates to a sand core for casting a housing of an element for compressing or expanding a gas, wherein the sand core comprises a partial core having a profile for fully or largely forming an inner surface or interior space of the housing.

### BACKGROUND

In this context, a “profile for largely forming an inner surface or interior space of the housing” means that at least 50%, preferably at least 60%, more preferably at least 70%, even more preferably at least 80% and still more preferably at least 90% of the inner surface of the housing is formed by the profile of the partial core.

Casting processes are known from the prior art in which molten casting material, typically gray or ductile cast iron, is poured into an internal mold cavity in a sand mold via a runner.

When the mold cavity in the sand mold is filled with this molten casting material, a casting is at least partially formed by a surface of the mold cavity.

In this case, both an outer surface and an inner surface or interior space of the casting can be at least partially formed by the surface of the mold cavity.

A housing of an element for compressing or expanding a gas as a casting has an inner surface that typically has a complex shape, which complex shape is also manifested in a part of a sand core positioned in the sand mold to form the inner surface.

Conventional tools used to manufacture the sand core for the housing, such as patterns and molds, are expensive to produce because of this complex shape, but also expensive to adapt and store.

Over time, these conventional tools are also susceptible to wear.

Some very complex shapes cannot even be realized with conventional tools.

Due to the complex shape, a part of the sand core must typically be constructed from various components in order to fully or largely form the inner surface.

As a result, these components must be designed to be compatible with one another, which can limit the design freedom of the components and ultimately also the sand core.

In addition, specific tools are required to manufacture a plurality of these components.

The construction of this part of the sand core from the various components also implies
a certain construction time;
a certain risk of breaking a brittle component;
a certain risk of construction errors;
a certain dimensional inaccuracy due to tolerance stack-up; and
more formation of waste material.

The sand core and its various components are also typically solid, with no internal cavities, which can make the sand core costly in material, heavy in weight, and difficult to handle.

This invention aims at solving at least one of the aforementioned disadvantages and/or other disadvantages.

### SUMMARY OF THE INVENTION

More specifically, the object of the invention is to provide a sand core and method for casting a housing of an element for compressing or expanding a gas,
which housing is cheaper and faster to manufacture, easy to handle and design, and dimensionally accurate in comparison with existing sand cores or methods for casting such a housing.

Furthermore, the object of the invention is to provide a method for manufacturing a sand core for casting a housing of an element for compressing or expanding a gas that is faster, cheaper, more flexible, and more accurate than existing methods for manufacturing such a housing.

For this purpose, the invention relates to a sand core for casting a housing of an element for compressing or expanding a gas,
wherein the sand core comprises a partial core having a profile for fully or largely forming an inner surface or interior space of the housing of the housing, characterized in that the partial core consists of one integral monoblock structure.

In this context, “one integral monoblock structure” means that the partial core consists of a single continuous or cohesive piece of material. In other words, the material of the partial core is not broken into a plurality of separate pieces or components.

By designing the partial core as one integral monoblock structure, the partial core no longer needs to be constructed from various components.

The advantages of such a partial core consisting of one integral monoblock structure over a partial core consisting of a plurality of components therefore include, among other things
shorter production time;
reduced risk of breaking the partial core during handling, for example when transporting the partial core or when assembling the sand core;
no risk of construction errors;
no tolerance stack-up by assembling the partial core from various components, and consequently a higher dimensional accuracy; and
less formation of waste material.

In addition, it is no longer necessary to design various components of the partial core to be compatible with one another, which increases the design freedom of the components and ultimately also of the sand core. In addition, there is no need for a large number of specific tools to manufacture each component.

Providing a complex geometry for the integral monoblock structure of the partial core is possible, for example, by manufacturing the partial core using an additive production technique.

In a preferred embodiment of the sand core according to the invention, the integral monoblock structure comprises a means for handling the integral monoblock structure.

This increases the ease of handling of the partial core, as a result of which
a risk of inaccurate assembly or a risk of breaking the partial core when placing the partial core in the sand core and/or sand mold can be reduced;
the partial core can be cleaned more easily; and
visual inspection of the partial core is easier, thereby reducing the risk of quality issues in the partial core.

In a subsequent preferred embodiment of the sand core according to the invention, the sand core comprises a second partial core having a second profile for at least partially forming an outer surface of the housing.

In this way, the outer surface of the housing can also be at least partially formed by the sand core during the casting process of the housing.

Preferably, the integral monoblock structure and the second partial core are in this case integrally connected to one another by means of at least one inter-core connection.

In this way, the integral monoblock structure and the second partial core together form an integral structure that is even larger than the integral monoblock structure itself.

As a result of this, on the one hand the partial core consisting of the integral monoblock structure, and on the other hand the second partial core can be accurately positioned with respect to one another when assembling the sand core and can remain accurately positioned with respect to one another while the sand core is being placed in the sand mold and during the casting of the housing.

In a subsequent preferred embodiment of the sand core according to the invention, the sand core comprises a hollow structure having a cavity, which hollow structure is configured in such a way that, during the casting of the housing, the cavity is not accessible to the casting material used to form the housing.

In this case, both the partial core consisting of the integral monoblock structure and the second partial core or other partial core of the sand core can be designed as a hollow structure.

The advantages of designing the sand core with a hollow structure include, among other things
reduced weight of the sand core;
a reduced material cost for the sand core; and
reduced gas formation and therefore less degassing required during casting of the housing.

Because the partial core consists of one possibly bulky integral monoblock structure, it is important to limit the weight of the partial core to optimize the ease of handling of this partial core, especially in the case of a partial core in a sand core for casting a bulky housing.

In this case, designing the integral monoblock structure as a hollow structure thus provides a specific advantage in terms of ease of handling of the partial core, especially when the partial core is bulky and heavy in weight.

The invention also relates to a sand mold for casting a housing of an element for compressing or expanding a gas, wherein the sand mold contains a sand core according to any one of the preceding embodiments.

It goes without saying that such a sand mold has the same advantages as the above-described embodiments of a sand core according to the invention.

The invention also relates to a method for manufacturing a sand core for casting a housing of an element for compressing or expanding a gas, characterized in that the sand core is manufactured by means of an additive production technique.

Advantages of manufacturing the sand core with an additive production technique over manufacturing a sand core with a subtractive production technique include, among other things
no need to dispose of removed or cut material during manufacturing of the sand core;
reduced machining allowance due to optimal and iterative design or the elimination of release angles, resulting in
   reduced machining time;
   reduced cost; and
   reduced material and energy consumption;
elimination of the use of specific and difficult to adapt tools, such as core boxes, pattern plates and molds;
greater design freedom to provide the sand core with a complex geometry in a fast, flexible and dimensionally accurate manner, for example
   a hollow geometry;
   a geometry with degassing channels and/or holes along which the sand core can be cleaned of excess sand;
   a geometry for a housing having an optimized flow behavior of fluids through a cooling jacket and/or oil channels in the housing;
   a geometry having characteristics that allow easy and safe handling and transport of the sand core; and/or
   a geometry having characteristics that facilitate the casting process and machining process of the housing, for example due to stable clamping or the elimination or reduction of tolerance stack-up.

In terms of flexibility, an additive production technique allows the design of the sand core to be quickly and accurately adapted and optimized in an iterative manner without the need to modify standard tools.

In this case, the sand core is preferably one of the embodiments described above.

It goes without saying that a sand core manufactured using the method according to the invention has the same advantages as the above-described embodiments of a sand core according to the invention.

Finally, the invention relates to a method for casting a housing of an element for compressing or expanding a gas, characterized in that the method comprises the following steps:
pouring a molten casting material against a surface of a sand core according to any one of the above-described embodiments;
solidifying the casting material against the surface of the sand core to form the housing, wherein an inner surface or interior space of the housing is formed fully or largely by the profile of the integral monoblock structure.

It goes without saying that the advantages of the sand core according to any of the above-described embodiments also apply to this method according to the invention.

In this case, an outer surface of the housing is also preferably at least partially formed by the sand core.

In this way, during the casting of the housing, both the inner surface or the interior space of the housing and at least a portion of the outer surface of the housing can be formed by the same sand core.

### BRIEF DESCRIPTION OF THE INVENTION

With a view to better demonstrating the characteristics of the invention, a number of preferred applications of a sand core and a method according to the invention for casting a housing of an element for compressing or expanding a gas are described below, by way of example without any restrictive character, with reference to the accompanying drawings, in which:

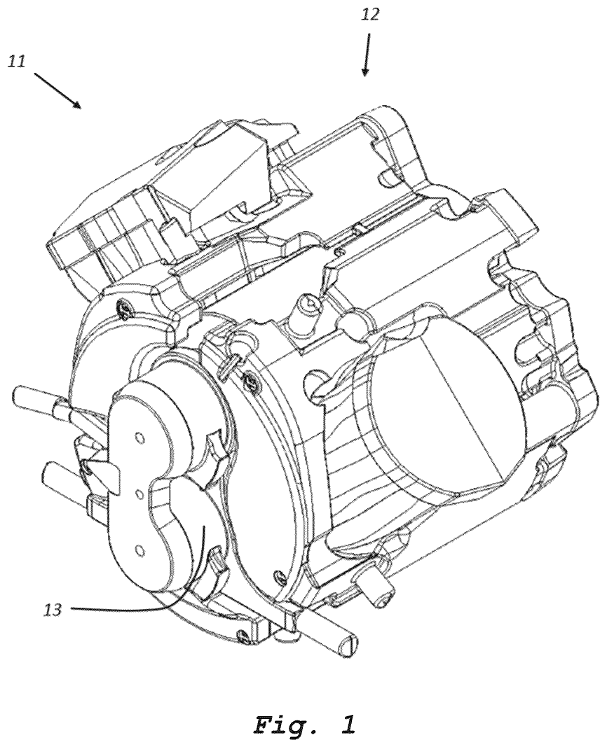

FIG. 1 shows a first embodiment of a sand core according to the invention;

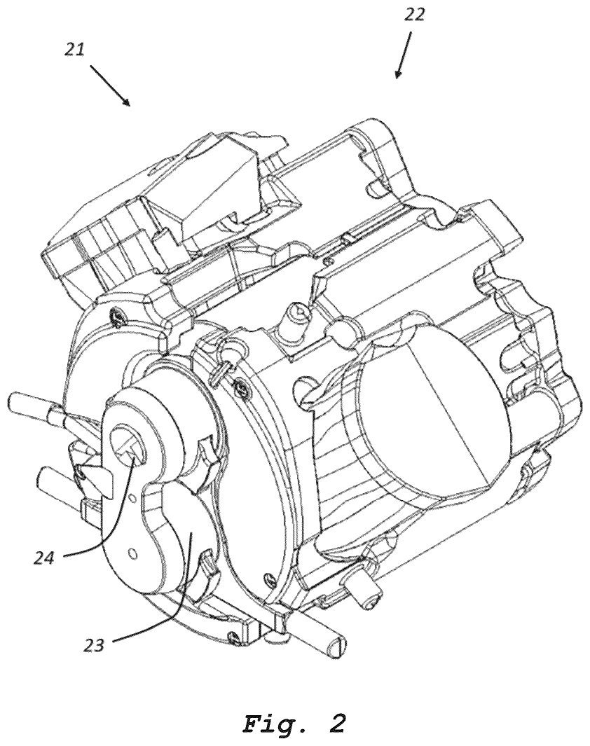

FIG. 2 shows a second embodiment of the sand core according to the invention; and

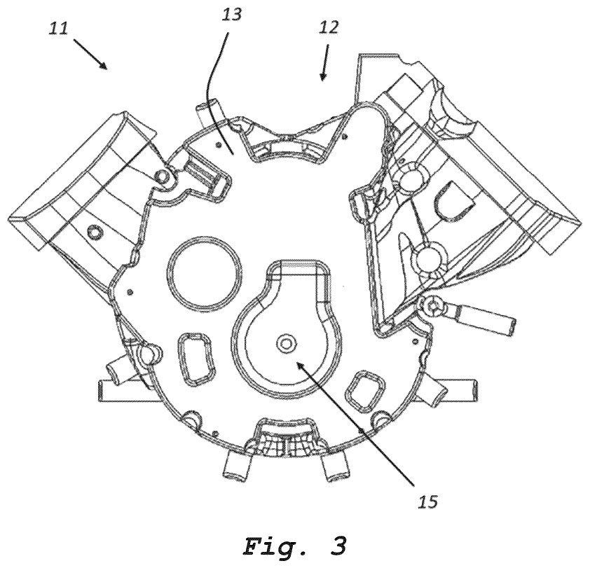

FIG. 3 is a bottom view of the sand core in FIG. 1.

### DETAILED DESCRIPTION OF THE INVENTION

FIG. 1 shows a sand core 11 according to the invention for casting a housing of an element for compressing or expanding a gas.

The sand core comprises a partial core 12 having a profile for fully or largely forming an inner surface or interior space of the housing during the casting of the housing.

Said partial core 12 consists of one integral monoblock structure 13.

FIG. 2 shows a second embodiment of the sand core 21 according to the invention with an alternative integral monoblock structure 23 as the partial core 22.

In this second embodiment according to the invention, the sand core 21 is provided with a means 24 for handling the integral monoblock structure 23.

Said means 24 can take a plurality of forms:
first, at least one recess or opening in the integral monoblock structure 23, such as a slot in this case; and/or
second, at least one protrusion of the integral monoblock structure 23, such as a handle protruding from the integral monoblock structure 23.

Within the scope of the invention, it is not ruled out that the means 24 is positioned at a different location of the integral monoblock structure 23.

FIG. 3 is a bottom view of the sand core 11 in FIG. 1.

In this bottom view, it can be seen that the integral monoblock structure 13 is a hollow structure having a cavity 15.

The hollow structure is configured in such a way that, during the casting of the housing, the cavity 15 is not accessible to the casting material used to form the housing.

Within the scope of the invention, it is not ruled out that the sand core comprises other partial cores in addition to the partial core consisting of the integral monoblock structure.

In this way, the sand core can comprise a second partial core having a second profile for at least partially forming an outer surface of the housing.

Said second partial core can be integrally connected to the integral monoblock structure by means of at least one inter-core connection.

An example of a method according to the invention for casting a housing of an element for compressing or expanding a gas is described as follows.

In a first step of the method according to the invention, molten casting material is poured against a surface of a sand core according to the invention.

Then, the casting material is solidified against the surface of the sand core to form the housing, wherein at least one inner surface or interior space of the housing is formed fully or largely by the profile of the integral monoblock structure of the partial core of the sand core.

Within the scope of the invention, at least a portion of an outer surface of the housing can also be formed during the solidification of the casting material against the surface of the sand core.

According to the invention, it is not ruled out that the sand core is first pre-treated before the molten casting material is poured against the sand core. For example, a surface of the sand core can be at least partially provided with a coating to prevent burn-in of the sand and to reduce or even eliminate rough zones on a surface of the formed housing.

The invention is by no means limited to the sand core and method described by way of example and shown in the figures, but a sand core according to the invention can be realized in a variety of forms and dimensions, and a method according to the invention can be realized in a wide variety of versions, without exceeding the scope of protection of the invention as defined in the claims.

1-11. (canceled)

12. A sand core for casting a housing of an element for compressing or expanding a gas,
wherein the sand core comprises a partial core having a profile for fully or largely forming an inner surface or interior space of the housing,
wherein the partial core includes one integral monoblock structure.

13. The sand core according to claim 12, wherein the integral monoblock structure comprises a means for handling the integral monoblock structure.

14. The sand core according to claim 12, wherein the sand core comprises a second partial core having a second profile for at least partially forming an outer surface of the housing.

15. The sand core according to claim 14, wherein the integral monoblock structure and the second partial core are integrally connected to one another by means of at least one inter-core connection.

16. The sand core according to claim 12, wherein the sand core comprises a hollow structure having a cavity, which hollow structure is configured in such a way that, during the casting of the housing, the cavity is not accessible to the casting material used to form the housing.

17. The sand core according to claim 16, wherein the integral monoblock structure is the hollow structure.

18. A sand mold for casting a housing of an element for compressing or expanding a gas, wherein the sand mold comprises a sand core according to claim 12.

19. A method for manufacturing a sand core according to claim 12 for casting a housing of an element for compressing or expanding a gas, wherein the sand core is manufactured by means of an additive production technique.

20. A method for casting a housing of an element for compressing or expanding a gas, comprising the following steps:
pouring a molten casting material against a surface of a sand core according to claim 12; and
solidifying the casting material against the surface of the sand core to form the housing, wherein an inner surface or interior space of the housing is formed fully or largely by the profile of the integral monoblock structure.

21. The method according to claim 20, wherein an outer surface of the housing is also at least partially formed by the sand core.
